(19) United States
(12) Patent Application Publication
(10) Pub. No.: US 2012/0089368 A1
(43) Pub. Date: Apr. 12, 2012

(54) POWER CYCLE TEST APPARATUS AND METHOD FOR TESTING POWER CYCLE OF COMPUTING DEVICE

(75) Inventors: HAI-LI WANG, Shenzhen City (CN); XIAN-KUI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/034,621

(22) Filed: Feb. 24, 2011

(30) Foreign Application Priority Data
Oct. 11, 2010 (CN) 201010503136.6

(51) Int. Cl. G06F 19/00

(52) U.S. Cl. 702/183

(57) ABSTRACT

A method controls a computing device to perform a power cycle test by switching a power supply on or off using a power cycle test apparatus. The apparatus includes a timer, a counter, a power rectifier, and a display unit. The timer sets a test period of the power cycle test, controls the power rectifier to switch the power supply on, counts a test time of the power cycle test at the begin time of the test period, and controls the power rectifier to switch the power supply off when the test period elapses. The power rectifier transforms AC supplied by the power supply into DC when the power supply is switched on, provides the AC to the computing device to perform a power-on test process, and controls the computing device to perform a power-off test process when the power supply is switched off.

### BACKGROUND

1. Technical Field

Embodiments of the present disclosure relate to methods and apparatuses for testing computing devices, and particularly to an apparatus and method for testing a power cycle of a computing device.

2. Description of Related Art

Computing devices, such as personal computers, notebook computers, or servers, must be tested for performance before the computing device is distributed into the consumer market. In order to control and improve the performance of the computing device, one or more power cycle tests should be performed to test the computing device. However, presently, the one or more power cycle tests must be performed individually, and a lot of manual work is required during each power cycle test. The efficiency and accuracy of each power cycle test cannot be ensured.

### BRIEF DESCRIPTION OF THE DRAWINGS

FIG. 1 is a block diagram of one embodiment of an apparatus for testing a power cycle of a computing device.

FIG. 2 is a flowchart of one embodiment of a method for testing power cycle of a computing device using the apparatus of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

As used herein, the term “power cycle test” is defined as a cold boot test that is to repeatedly execute actions of power-on and power-off test processes in a certain time interval, to test whether the computing device boots properly. For example, if a computer is able to start the operating system (OS) when the computer is powered on, then it is considered as a normal power-on test process. Likewise, if the computer is able to exit the OS when the computer is powered off, then it is consider as a normal power-off test process.

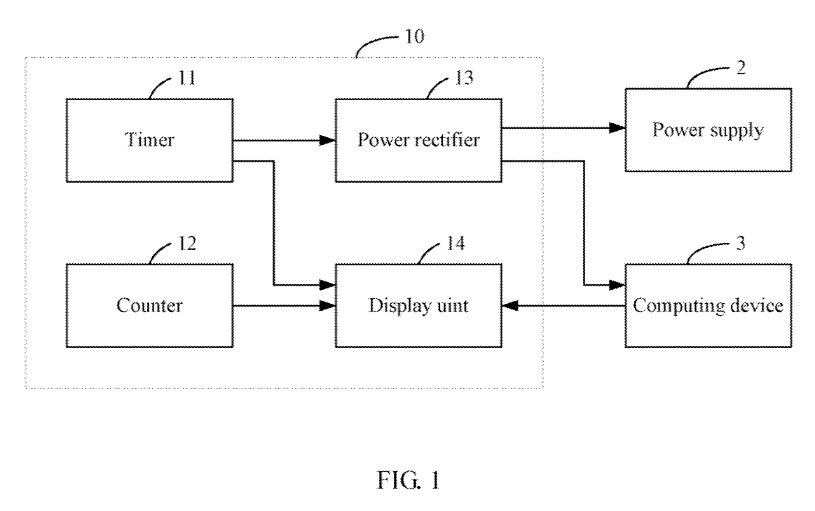

FIG. 1 is a block diagram of one embodiment of a power cycle test apparatus 10.

In the embodiment, the power cycle test apparatus 10 can control a computing device 3 to perform a power cycle test by switching a power supply 2 on or off automatically. In one embodiment, the power cycle test may be an alternating current (AC) test, or a direct current (DC) test. The power supply 2 is an AC power device that supplies AC to the computing device 3 for performing the AC power cycle test, or a DC power device that supplies DC to the computing device 3 for performing the DC power cycle test. The computing device 3 includes, but is not limited to, personal computer (PC), a notebook computer, and a server.

In one embodiment, the power cycle test apparatus 10 includes a timer 11, a counter 12, a power rectifier 13, and a display unit 14. The power rectifier 13 connects to the timer 11, and is connected with the power supply 2 and the computing device 3 respectively. The display unit 14 connects to the computing device 3, and is connected with the timer 11 and the counter 12 respectively. It should be understood that FIG. 1 illustrates only one example of the apparatus 10, and may include more or fewer components than illustrated, or a different configuration of the various components in other embodiments.

The timer 11 is operable to set a test period of the power cycle test for the computing device 3, and control the power rectifier 13 to switch the power supply 2 on or off according to the test period. In one embodiment, the test period is defined as a period that the computing device 3 performs a power-on operation and a power-off operation, and can be set to different times, such as 30 seconds or 60 seconds, according to requirements of the computing device 3. For example, the timer 11 controls the power rectifier 13 to switch the power supply 2 on at the beginning of the test period, and controls the power rectifier 13 to switch the power supply 2 off at the end of the test period (i.e., the 60^{th} second).

The timer 11 is further operable to start to count a test time of the power cycle test when the power rectifier 13 switches the power supply 2 on, and determines whether the test time is equal to the test period. When the test time equals the test period, the timer 11 controls the power rectifier 13 to switch the power supply 2 off.

The counter 12 is operable to set a test number of the power cycle test for the computing device 3, which is denoted as a number “N,” for example, N=50. When the computing device 3 performs one power cycle, the counter 12 decreases the test number by one, i.e., N=N−1. The counter 12 is operable to determine whether the test number is equal to zero. If the test number is not equal to zero, the computing device 3 performs another power cycle.

The power rectifier 13 is operable to transform AC supplied by the power supply 2 into DC when the power supply 2 is switched on, and provides the AC to the computing device 3 to perform a power-on test process of the computing device 3. When the power supply 2 is switched off, the power rectifier 13 disconnects the power supply 2 with the computing device 3 to perform a power-off test process of the computing device 3.

The display unit 14 is operable to display the test time and the test number in real time, and display a test result of the power cycle test of the computing device 3 when the test number is equal to zero. The test result may include a normal power-on times that denotes the computing device 3 passes the power cycle test, and a normal power-off times that denotes the computing device 3 fails the power cycle test. In the embodiment, the display unit 14 may be a light-emitting diode (LED), or a seven-segment display that can display the test time and the test number in a digital number format.

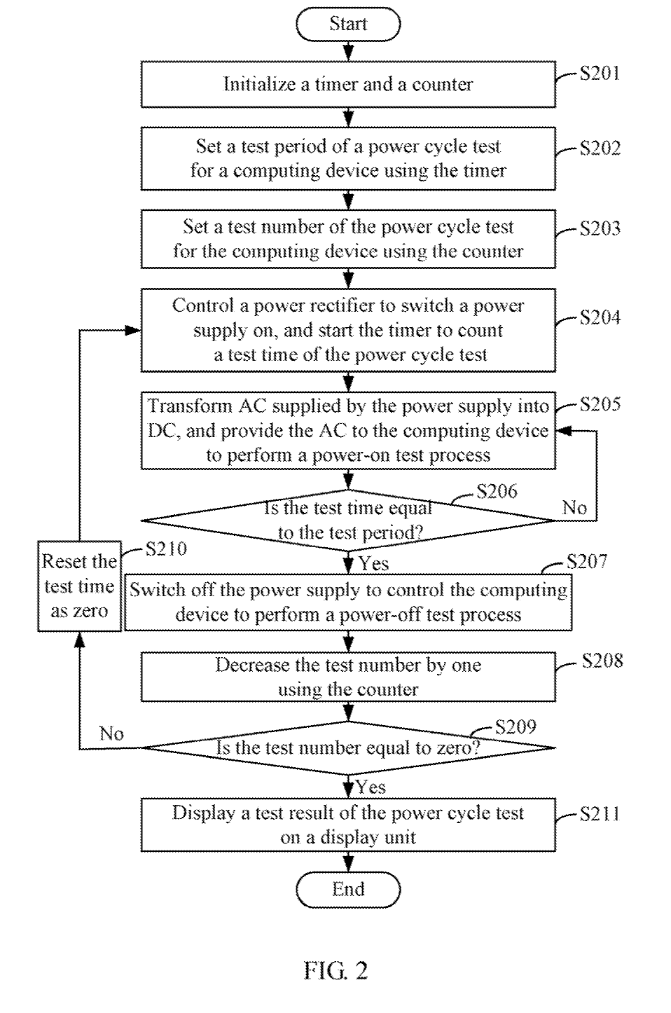

FIG. 2 is a flowchart of one embodiment of a method for testing a power cycle of a computing device using the apparatus 10 of FIG. 1. The method can control the computing device 3 to perform an AC power cycle test by switching the power supply 2 on or off automatically. Depending on the embodiment, additional blocks may be added, others removed, and the ordering of the blocks may be changed.

In block S201, the power cycle test apparatus 10 initializes the timer 11 and the counter 12. Before testing the power cycle of the computing device 3, the timer 11 initializes a test time as zero, and the counter 12 initializes a test number as zero.

In block S202, the timer 11 sets a test period of the power cycle test for the computing device 3 when the power cycle test begins. In one embodiment, the test period is defined as a period that the computing device 3 performs a power-on operation and a power-off operation, and can be set to different times, such as 30 seconds or 60 seconds, according to requirements of the computing device 3.

In block S203, the counter 12 sets a test number of the power cycle test for the computing device 3. In one embodiment, the test number is denoted as a number “N,” and can be set different numbers according to requirements of the tester, for example, N=50.

In block S204, the timer 11 controls the power rectifier 13 to switch the power supply 2 on at the begin time of the test period, and starts to count a test time of the power cycle test when the power rectifier 13 switches the power supply 2 on.

In block S205, the power rectifier 13 transforms AC supplied by the power supply 2 into DC when the power supply 2 is switched on, and provides the AC to the computing device 3 to perform a power-on test process of the computing device 3.

In block S206, the timer 11 determines whether the test time is equal to the test period. If the test time is equal to the test period, block S207 is implemented. Otherwise, if the test time is not equal to the test period, block S205 is repeated.

In block S207, the timer 11 controls the power rectifier 13 to switch the power supply 2 off. In one embodiment, the timer 11 controls the power rectifier 13 to switch the power supply 2 off at the end time of the test period (i.e., the 60^{th} second). When the power supply 2 is switched off, the power rectifier 13 disconnects the power supply 2 with the computing device 3 to perform a power-off test process of the computing device 3.

In block S208, the counter 12 decreases the test number by one, i.e., N=N−1. In block S209, the counter 12 determines whether the test number is equal to zero. If the test number is not equal to zero, block S210 is implemented. Otherwise, if the test number is equal to zero, block S211 is implemented.

In block S210, the timer 11 resets the test time as zero, and the flow goes to block S204. In block S211, the display unit 14 displays the test time and the test number, and displays a test result of the power cycle test of the computing device 3 when the test number is equal to zero. In the embodiment, the test result may include a normal power-on times that denotes the computing device 3 passes the power cycle test, and a normal power-off times that denotes the computing device 3 fails the power cycle test.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An apparatus for testing a power cycle of a computing device, the apparatus comprising:
a power rectifier operable to transform alternating current (AC) supplied by a power supply into direct current (DC) when the power supply is switched on, provide the AC to the computing device to perform a power-on test process, and disconnect the power supply with the computing device to perform a power-off test process when the power supply is switched off; and
a timer operable to set a test period of a power cycle test for the computing device, control the power rectifier to switch the power supply on, count a test time of the power cycle test at the begin time of the test period, and control the power rectifier to switch the power supply off when the test period elapses.

2. The apparatus according to claim 1, wherein the power supply is an AC power device that supplies the AC to the computing device for performing an AC power cycle test, or a DC power device that supplies the DC to the computing device for performing a DC power cycle test.

3. The apparatus according to claim 1, further comprising a counter that is operable to set a test number of the power cycle test, decrease the test number by one when the computing device performs one power cycle test, and determine whether the test number is equal to zero.

4. The apparatus according to claim 3, wherein the timer is further operable to reset the test time as zero when the test number is not equal to zero.

5. The apparatus according to claim 3, further comprising a display unit that is operable to display the test time and the test number in real time, and display a test result of the power cycle test when the test number is equal to zero.

6. The apparatus according to claim 5, wherein the display unit is a light-emitting diode (LED), or a seven-segment display that displays the test time and the test number in a digital number format.

7. The apparatus according to claim 1, wherein the computing device is a personal computer (PC), a notebook computer, or a server.

8. A method for testing a power cycle of a computing device, the method comprising:
setting a test period of a power cycle test for the computing device using a timer;
controlling a power rectifier to switch a power supply on, and counting a test time of the power cycle test at the begin time of the test period;
transforming alternating current (AC) supplied by the power supply into direct current (DC);
providing the AC to the computing device to perform a power-on test process;
controlling the power rectifier to switch the power supply off when the test period elapses; and
disconnecting the power supply with the computing device to perform a power-off test process.

9. The method according to claim 8, wherein the power supply is an AC power device that supplies the AC to the computing device for performing an AC power cycle test, or a DC power device that supplies the DC to the computing device for performing a DC power cycle test.

10. The method according to claim 8, further comprising:
setting a test number of the power cycle test.

11. The method according to claim 10, further comprising:
decreasing the test number by one when the computing device performs one power cycle test;
determining whether the test number is equal to zero;
resetting the test time as zero if the test number is not equal to zero, and performing a next power cycle test; and
displaying a test result of the power cycle test on a display unit if the test number is equal to zero.

12. The method according to claim 11, further comprising:
displaying the test time and the test number in real time on the display unit; and

13. The method according to claim 12, wherein the display unit is a light-emitting diode (LED), or a seven-segment display that displays the test time and the test number in a digital number format.

14. The method according to claim 8, wherein the computing device is a personal computer (PC), a notebook computer, or a server.
